(19) United States
(12) Patent Application Publication
(10) Pub. No.: US 2005/0232575 A1
(43) Pub. Date: Oct. 20, 2005

(54) Methods and apparatus for protecting imaging media from contaminants

(75) Inventor: Jacob Koren, Haifi (IL)

Correspondence Address: BETH READ;PATENT LEGAL STAFF, EASTMAN KODAK COMPANY, 343 STATE STREET, ROCHESTER, NY, 14650-2201, US

(73) Assignee: OREX Computed Radiography Ltd., Yokneam (IL)

(21) Appl. No.: 10/798,798

(22) Filed: Mar. 11, 2004

Related U.S. Application Data
(60) Provisional application No. 60/453,593, filed on Mar. 11, 2003.

(51) Int. Cl. H04N 5/76

(52) U.S. Cl. 386/46; 386/125

(57) ABSTRACT

A protective cover for various image recording media, such as film and phosphor media, and for cassettes that encase said media. The protective cover is arranged to substantially enclose the cassette during storage and/or exposure to X-rays and then removed (and perhaps disposed of) during acquisition of the latent image stored on the image recording media, for example, by an image reader such as a laser scanning device. The protective cover prevents contaminants from contacting the cassette and/or image recording media, thus extending the lifetime of the equipment.

### RELATED APPLICATIONS

This application claims the benefit under 35 U.S.C. §119(e) of U.S. Provisional Application 60/453,593 filed Mar. 11, 2003, entitled “METHODS AND APPARATUS FOR PROTECTING IMAGING MEDIA FROM CONTAMINANTS,” by Koren, which is incorporated herein in its entirety.

### FIELD OF THE INVENTION

The present invention relates to image recording media, such as film and phosphor media, and more particularly, to the protection of the image recording media during storage, use, etc.

### BACKGROUND OF THE INVENTION

The field of imaging, and particularly medical and dental imaging, has employed X-ray and other high energy radiation technologies to obtain images of the internal structures of an object. For example, medical and dental imaging techniques have been employed to obtain images of the body of a patient to facilitate diagnosis of diseases such as cancer, identify structural abnormalities, tissue anomalies, broken bones, etc.

Imaging techniques often include placing an object to be imaged between a high energy electromagnetic radiation source and an image recording medium. As radiation from the source passes through the object, it is absorbed at varying levels by the internal structures of the object. Upon exiting the object, the radiation impinges on the image recording medium with an intensity related to the attenuation of the radiation caused by the different absorption characteristics of the internal structures of the object being imaged. The impinging radiation causes a change in the image recording medium that is proportional to its intensity, thereby storing information about the internal structure of the object. The image recording medium may then be processed to recover the stored information by, for instance, converting it into digital form.

The term “image recording media” refers generally to media responsive to electromagnetic radiation, typically in high energy spectra such as X-rays. Image recording media typically record image information by being modified (e.g., by storing energy, by chemical alteration, etc.) according to the amount and/or intensity of electromagnetic radiation impinging on the media. Common types of image recording media include sheet film, phosphor media, etc.

Phosphor plate technology has emerged as a valuable image recording medium for computed radiography (CR). When electromagnetic radiation, such as X-ray radiation, impinges on a phosphor plate, the radiation interacts with the phosphor lattice of the plate. The phosphors in the plate store energy proportional to the intensity of the impinging radiation. This energy can later be released by scanning the plate with a laser to excite the phosphors in the plate (i.e., by causing the phosphors to fluoresce). The excited phosphors release radiation that can be detected, quantified and stored as values representing pixels in an image.

Phosphor plates have a generally desirable characteristic in that they may be reused for multiple exposures. For example, a phosphor plate may be exposed to radiation, scanned by an image reader to form a digital image of the internal structures of a patient, and then “erased” by exposing the plate to a bright flash of light (i.e., by substantially releasing any residual energy stored in the phosphor plate). The phosphor plate may then be exposed again to X-ray radiation to store another latent image.

An image recording medium typically must be protected from inadvertent exposure to radiation during the imaging process, and during transport from the radiation source (e.g., an X-ray scanner) to an image reader, to ensure that spurious information is not inadvertently recorded by the medium. In addition, the image recording medium may be vulnerable to physical damage such as scratches, tears, etc., that may occur during transport and use.

To mitigate some of the risk of damage, an image recording medium is often encased in a protective cassette before and during the imaging process. The term “cassette” refers generally to any of various casings, cartridges or containers adapted to hold, enclose or protect other material, and more particularly, to any of various image recording media that may benefit from protection and/or media that is susceptible to damage from direct handling, contact or exposure.

For example, a phosphor plate may be inserted into a cassette that forms a rigid shell or encasement around the phosphor plate. The cassette may be adapted so as to withstand the weight of a patient, rough handling, accidental falls, etc. Accordingly, cassettes are often employed to protect medical image recording media. However, the difference between medical and dental image recording media is generally one of size. For example, medical image recording medium are often of a dimension to image a portion of the body such as a torso or region of the torso. Dental image recording media are often of a dimension that is sized for placement inside the mouth. Accordingly, dental image recording media may be encased in material or cassette less rigid than a cassette adapted to withstand the stresses of medical imaging applications.

A phosphor plate typically remains inside the cassette during the exposure to radiation and during transport. Subsequently, the phosphor plate is removed from the cassette and loaded into an image reader. Both the phosphor plate and the cassette are intended to be reused for numerous exposures. Accordingly, to extend the lifetime of such equipment, care must be taken to protect both the image recording medium and the image recording cassette.

### SUMMARY OF THE INVENTION

One embodiment according to the present invention A protective cover adapted to substantially enclose an image recording cassette so as to significantly reduce a possibility of at least one contaminant contacting the cassette. The protective cover may be an envelope adapted to be placed over a container for at least one image recording medium during at least an imaging process involving the container, the envelope further adapted to be removed before reading information stored on the at least one image recording medium during the imaging process.

Another embodiment according to the present invention includes a plastic envelope to protect an image recording cassette, the plastic envelope substantially transparent to radiation in at least an X-ray spectrum. Another aspect of the present invention includes a plastic envelope that is substantially transparent to radiation in a visible spectrum.

Another embodiment according to the present invention includes a removable protective cover for an image recording cassette made from a material resistant at least to human bodily fluids.

Another embodiment according to the present invention includes a protective cover for an image recording cassette comprising a receptacle adapted to enclose the image recording cassette, an opening through which the image recording cassette may be inserted into the receptacle and a release through which the image recording cassette may be removed from the receptacle.

Another embodiment according to the present invention includes an envelope for protecting a cassette. The envelope comprises a front face and a back face joined to form a pouch having an opening through which the cassette may be inserted, at least one flap affixed proximate the opening and foldably arranged to allow the cassette to be inserted when the at least one flap is in an open position and to overlap the opening when the at least one flap is in a closed position, fastening means configured to hold the at least one flap in the closed position and a release configured to permit the cassette to be removed from the pouch when the at least one flap is in the closed position.

Another embodiment according to the present invention includes an envelope for protecting an image recording cassette from at least one contaminant. The envelope comprises a first open position to facilitate insertion of the image recording cassette into the envelope and a closed position adapted to substantially enclose the image recording medium.

Another embodiment according to the present invention includes a protective cover for an image recording device comprising a pouch having dimensions capable of substantially enclosing the image recording device, fastening means for securing the protective cover in a closed position and releasing means for removing the image recording device from the pouch.

Another embodiment according to the present invention includes a method of protecting a container for image recording media including an act of enclosing the container in a protective cover during at least one of storage and exposure of the container to a high energy radiation source.

Another embodiment according to the present invention includes method of extending the lifetime of an image recording cassette enclosing at least one image recording medium, the method including an act of encasing the image recording cassette in a protective cover except during times when information is being read from the at least one image recording medium.

Another embodiment according to the present invention includes a method of protecting an image recording medium encased in a cassette. The method comprises acts of inserting the cassette into a first protective envelope prior to exposure to electromagnetic radiation, exposing the cassette to electromagnetic radiation and removing the cassette from the first protective envelope subsequent to exposure to the electromagnetic radiation.

Another embodiment according to the present invention includes an image recording apparatus comprising an image recording medium, a cassette substantially enclosing the image recording medium and a removable protective cover substantially enclosing the cassette, the protective cover adapted to facilitate the prevention of at least one contaminant from contacting the cassette.

Another embodiment according to the present invention includes a protective covering comprising a receptacle adapted to substantially enclose an image recording cassette, the receptacle formed by material that substantially reduces a possibility of at least one contaminant from contacting the cassette, an opening through which the image recording medium may be inserted into the receptacle, and a release through which the image recording cassette may be removed from the receptacle.

It should be appreciated the all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter.

### DETAILED DESCRIPTION

Image recording cassettes are often designed to protect image recording media against accidental exposure to radiation and to ensure that the image recording medium is secure against harm that may arise from physical contact and/or trauma during the imaging process, transport between a radiation source and a CR image reader, loading and unloading of the image recording medium into the image reader, etc. An exemplary image recording cassette is described in U.S. Provisional Application Ser. No. 60/383,748 (hereinafter the '748 application), which is herein incorporated by reference in its entirety.

Various embodiments of the present invention discussed below derive from the Applicant's recognition and appreciation that the image recording cassettes as well as image recording media may be vulnerable to other contaminants such as bodily fluids from a patient, various agents in the environment (e.g., moisture, dust, chemicals, etc.) that may come into contact with a cassette and/or image recording medium during use. The term “contaminant” refers generally to any agent or substance that may damage a cassette or image recording media, that may be harmful to any imaging equipment or human operators, and/or that would generally need to be cleaned off or removed from a cassette were it to contact the cassette. Contaminants include, but are not limited to, bodily fluids such as blood, moisture, air-born particles such as dust, chemicals, medicines, etc.

For example, an emergency situation involving physical trauma to a patient may require the patient to be imaged in the field or immediately upon reaching a medical facility. Under such circumstances, a cassette may come into contact with a bleeding patient or material such as clothing that has been exposed to the patient's bodily fluids, harmful agents to which the patient has been exposed, and/or other substances used for patient treatment. Subsequently, the cassette must be carefully cleaned and sanitized before it can be reused and/or before it is loaded into an image reader. Considering the hazards of exposing patients, doctors and handlers of the cassettes to the bodily fluids of others and/or other possibly harmful substances, the cleaning process must be done with extreme care and is often relatively time consuming. Moreover, both the contact with potential contaminants and the cleaning process itself pose a threat of damage to the image recording medium, the cassette and/or the image reader, and may incur time consuming and often expensive cleaning procedures.

In addition, temporary and/or mobile medical facilities often do not have the capacity to completely sanitize the environment in which the facility operates. As such, image recording cassettes may be exposed to the humidity of the outside environment, dust, air-born contaminants, etc. For example, a military medical installment may be required to store and use cassettes in open air conditions or facilities that are exposed to substantial environmental contaminants. An unprotected cassette and image recording medium may be susceptible to damage from environmental conditions and/or contaminants that may result in loss of information, unrecoverable images, or damage to the cassette and/or image recording medium that render the equipment unuseable.

Applicant has identified and appreciated that a protective cover for image recording cassettes and, more particularly, a covering that can be removed, cleaned and/or disposed of, may reduce exposure to environmental conditions and contaminants, prevent loss and/or degradation to valuable image information, extend the lifetime of the image recording media and the cassette, and streamline the imaging process.

Many image readers, such as a laser scanning device, have a loader wherein a cassette that has been exposed to radiation is inserted such that the image recording medium may be removed from the cassette and scanned. Accordingly, a cassette may often have an opening through which an image recording medium may be removed from and returned to the cassette. In view of the foregoing, one embodiment of the present invention is directed to a protective cover that can be easily applied to an image recording cassette prior to exposure to radiation and removed prior to or concurrent with loading the cassette into the image reader. In this manner, the protective cover protects the cassette during one or more of storage, transport, and exposure, and does not interfere with the process of loading the cassette into the image reader and removing the image recording medium from the cassette for reading.

Following below are more detailed descriptions of various concepts related to, and embodiments of, methods and apparatus according to the present invention. It should be appreciated that various aspects of the invention, as discussed above and outlined further below, may be implemented in any of numerous ways, as the invention is not limited to any particular manner of implementation. Examples of specific implementations are provided herein for illustrative purposes only. In particular, while some embodiments of the invention discussed herein relate to a protective cover for an image recording cassette, it should be appreciated that protective covers according to other embodiments of the invention may be employed more generally with various types of containers or holders for image recording media, and also may be used directly with one or more image recording media (e.g., without a cassette, container, or other type of holder for the image recording media).

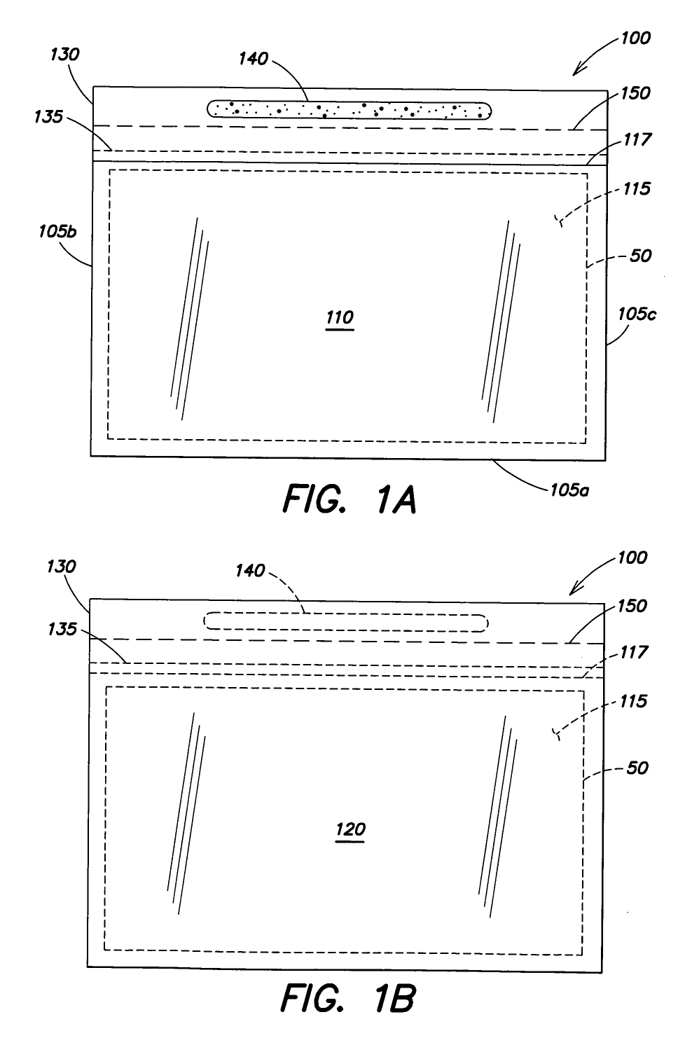

FIGS. 1A and 1B illustrate one embodiment of a protective cover or envelope according to the present invention. In FIGS. 1A and 1B (shown in a front view and a back view, respectively), envelope 100 is shown in one example of an open position. The term “open position” refers generally to an arrangement of an envelope in which an image recording cassette, for example, cassette 50, may be inserted or removed from the envelope.

Envelope 100 includes a front face 110 and a back face 120 that are joined together at edges 105a, 105b and 105c to form receptacle or pouch 115. Receptacle 115 may be of various sizes and dimensions so as to accommodate an image recording cassette 50. Front and back faces 110 and 120 may be, for example, a continuous sheet of plastic manufactured to form a receptacle capable of enclosing the cassette 50. Envelope 100 may include an opening 117 through which the cassette 50 may be inserted into the receptacle 115. For example, opening 117 may be formed by a free edge of the front face 110.

Envelope 100 may further include a flap 130 capable of being folded, for example, along fold line 135 such that it overlaps opening 117. In one aspect of this invention, flap 130 may include an adhesive strip 140 capable of securing the flap to the front face when the flap is folded down along the fold line 135.

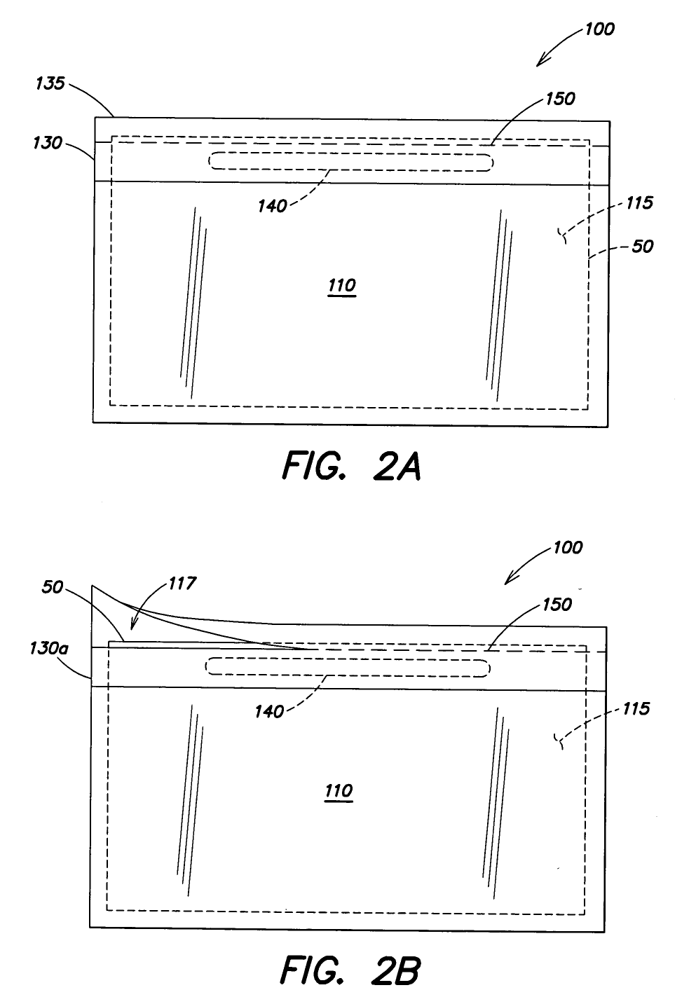

FIG. 2A illustrates envelope 100 in a closed position. The term “closed position” refers generally to an arrangement of an envelope wherein the envelope encloses a cassette 50 and is presumed to be significantly secure against exposure to one or more contaminants. That is, in the closed position, the contents of the envelope (i.e., the cassette 50) are not intended to be removed without further manipulation or rearrangement of the envelope.

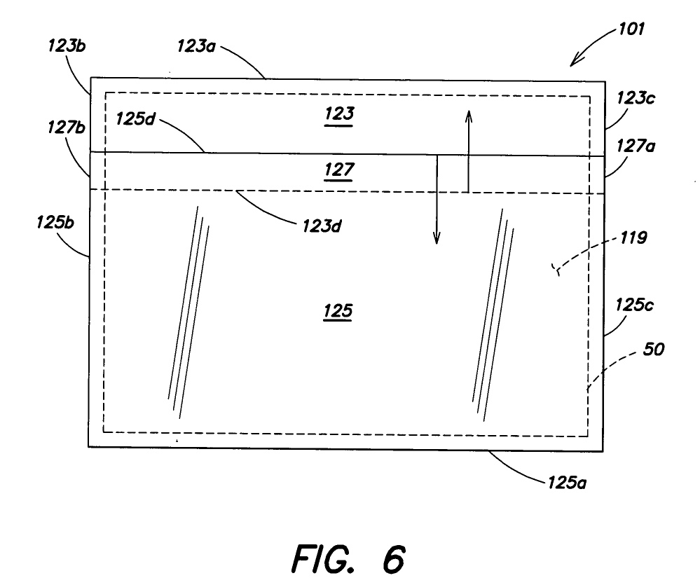

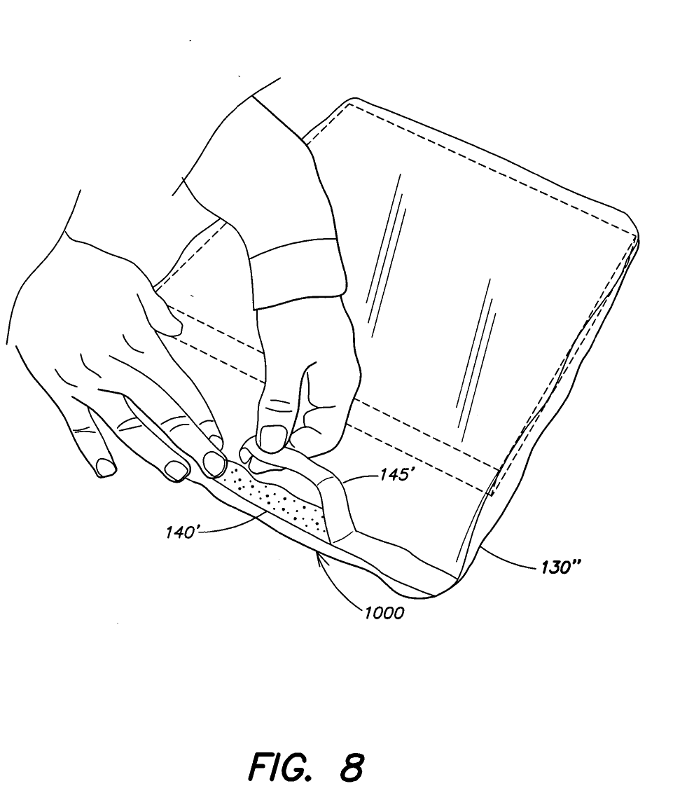

In FIG. 2A, cassette 50 has been inserted into the envelope and the flap 130 folded along the line 135 such that it overlaps the opening 117 shown in FIG. 1A and the adhesive strip 140 contacts the front face of the envelope and prevents the flap from returning to an open position. In one aspect, adhesive strip 140 may include a protective tab (e.g., as shown in FIG. 8) over the adhesive material to prevent the strip from adhering accidentally to other surfaces before the envelope is intended to be closed. It should be appreciated that adhesive strip 140 may be replaced with any fastening mechanism suitable for placing and securing the envelope in a closed position or may be left out altogether as described in connection with the embodiment illustrated in FIG. 6.

During an exemplary imaging process, an image recording cassette containing an image recording medium to be exposed to X-ray radiation is inserted into envelope 100 and flap 130 is folded over and secured to the front face 110 to close the envelope. The protected cassette may then be used to acquire an image of the internal structure of a patient. The patient, for example, may have been a victim in a car accident who may either have blood on his person or may still be bleeding. Other types of contaminating agents also may be present in the vicinity of the imaging process. The closed envelope provides protection for the cassette and image recording medium against contamination from the blood of the patient and perhaps other harmful agents that could damage the cassette or image recording medium.

After the patient has been imaged, the cassette may be transported to an image reader in order to acquire the latent image stored on the image recording medium inside the cassette. Typically, the image recording medium needs to be removed from the cassette and loaded into the image reader. Accordingly, in some cases, the envelope may need to be removed before the image recording medium can be removed from the cassette to be scanned.

In view of the foregoing, envelope 100 also may include a release that allows the cassette to be removed from the envelope after the envelope has been placed in the closed position. In one embodiment, as illustrated in FIGS. 1A, 1B, 2A and 2B, envelope 100 includes a perforation or tear line 150 that operates as a release through which the cassette may be removed. For example, as illustrated in FIG. 2B, the envelope may be torn along perforation 150 in order to separate a portion 130a of the flap from the back face of the envelope. As a result, the opening 117 into receptacle 115 is exposed and the cassette may be removed.

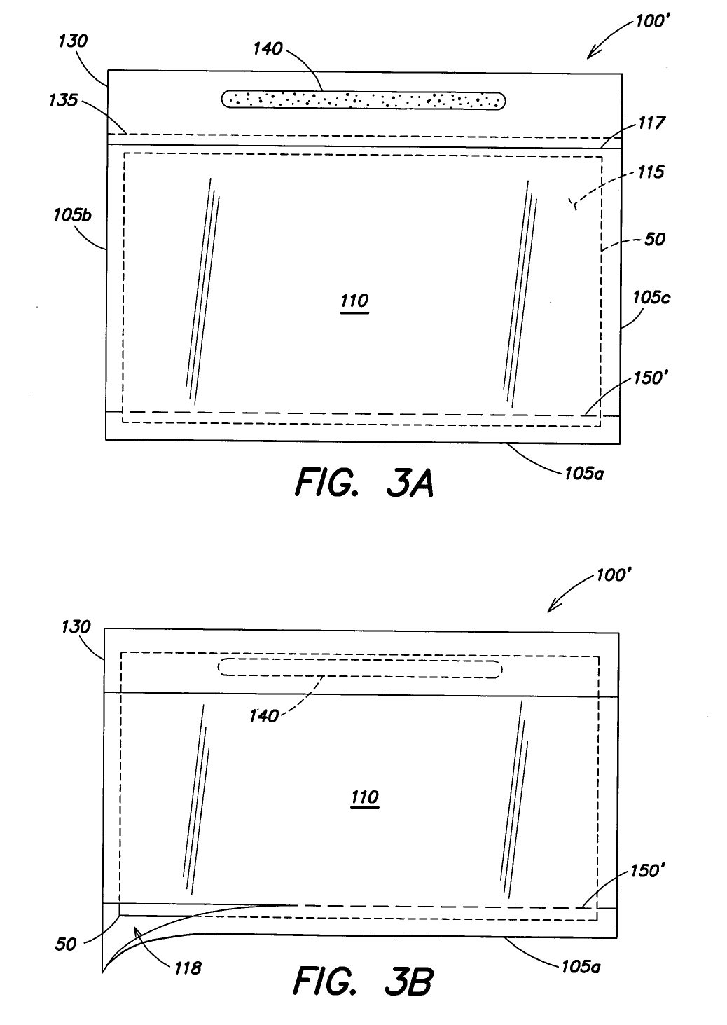

Alternately, the release may be on a side of the envelope other than the side having the opening 117. For example, FIGS. 3A and 3B illustrate another embodiment of an envelope 100′ wherein the perforation line 150′ is along edge 105a of the envelope. In this embodiment, a cassette is inserted into the envelope through a first opening 117 when the envelope is in an open position as shown in FIG. 3A. After the envelope has been closed, the cassette may be released from the envelope through a second opening 118 created by tearing the envelope along perforation line 150′ as shown in FIG. 3B.

It should be appreciated that the perforation or tear line may be disposed at locations other than those described above. For example, a perforation may be arranged along any of envelope edges 115a, 115b or 115c as shown in FIG. 3A. Moreover, the perforation may appear on the back face of the envelope, along a seam between the front and back faces, or may include more than one perforation.

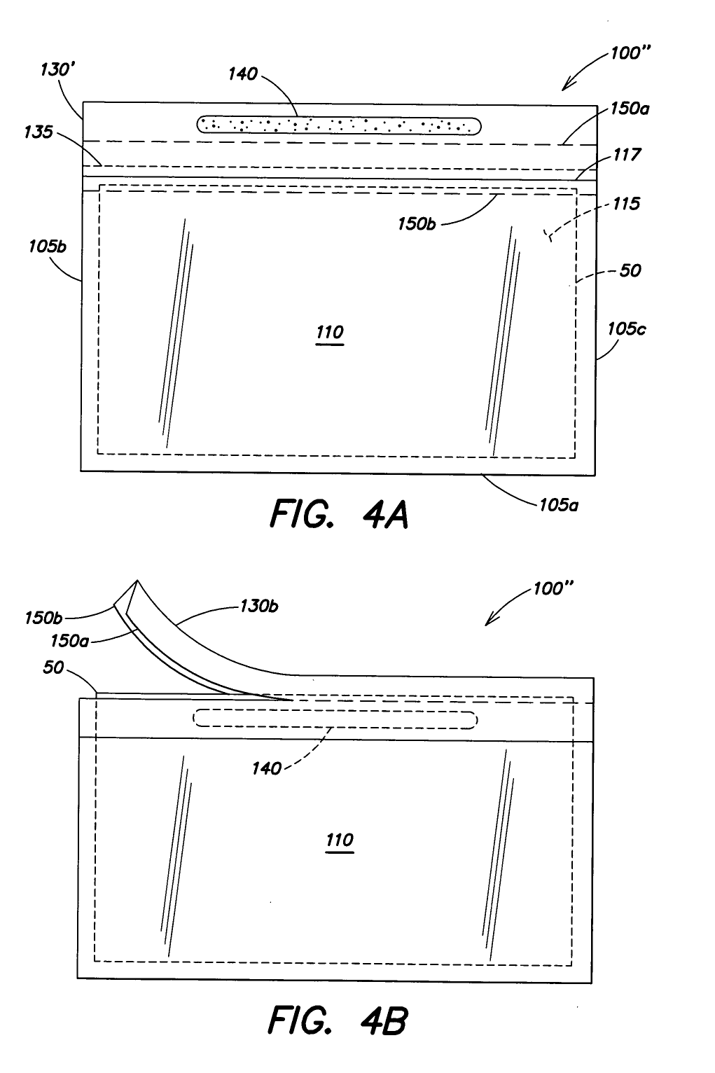

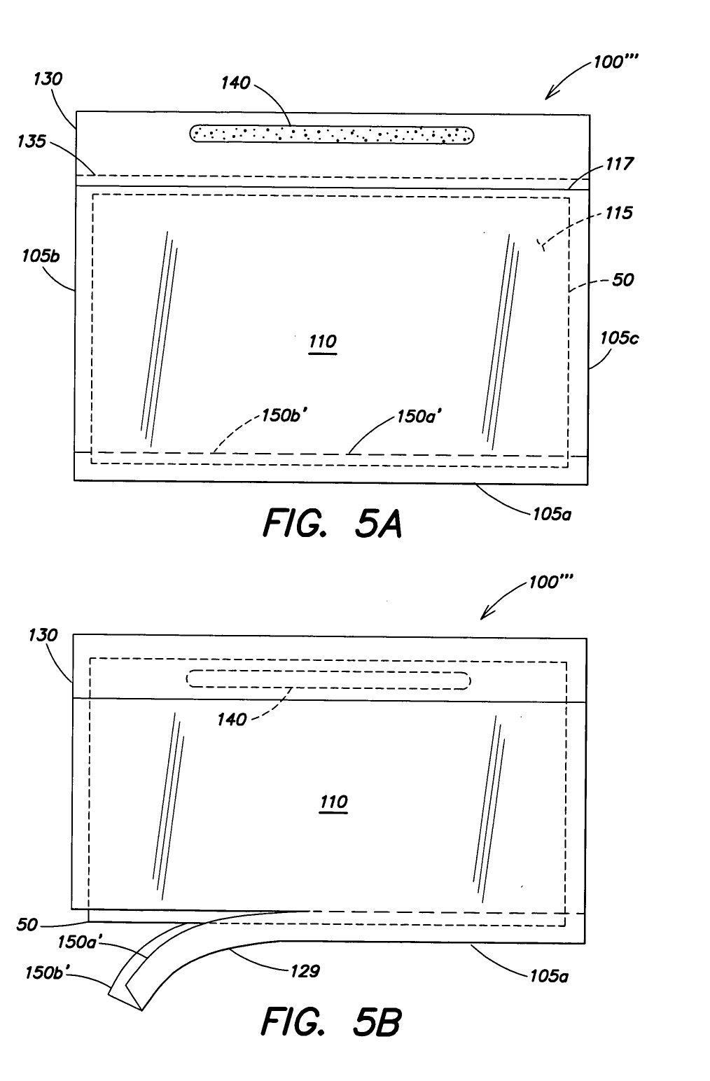

For example, in FIGS. 4A and 4B, a release is formed by a pair of perforations 150a and 150b. After an envelope 100″ has been closed by adhering flap 130′ to the front face 110 as described in connection with FIGS. 1A and 1B, a cassette 50 may be removed from the envelope by tearing along both perforations such that a portion 130b of flap 130′ is separated from the envelope. FIGS. 5A and 5B illustrate a pair of perforations 150a′ and 150b′ proximate a side 105a away from the opening 117. For example, perforation 150a′ may be disposed on the bottom portion of the front face near side 105a and the perforation 150b′ may be similarly disposed on the back face of the envelope. A cassette 50 may be removed from the envelope by tearing along perforations 150a′ and 150b′ to separate a portion 125 from the envelope as shown in FIG. 5B.

It should be appreciated that, in other embodiments of the present invention, the release need not be a perforation or tear line as discussed above. More generally, a release may include any configuration of an envelope that allows a cassette to be removed from the envelope and that does not jeopardize the protection of the cassette when the envelope is in a closed position.

For example, a release may be the opening through which the cassette was inserted as described in connection with FIG. 1A. The opening need not be re-exposed by tearing a perforation, but may be re-exposed by applying a force greater than the adhesive force such that the flap is disengaged from the front face and returned to an open position. In embodiments wherein the fastening mechanism is not an adhesive strip, for example, a velcro strip, a tie, fold, etc., the opening through which the cassette is removed may be made by unfastening the respective mechanism.

FIG. 6 illustrates yet another embodiment of a protective cover for an image recording cassette that uses neither an adhesive strip or a perforation for securing and releasing a cassette from the protective cover. Protective cover 101 includes a back face comprised of an upper portion 123 and a lower portion 125. Upper portion 123 has a perimeter formed by sides 123a, 123b, 123c and free edge 123d. Similarly, lower portion 125 has a perimeter formed by sides 125a, 125b, 125c and free edge 125d.

In FIG. 6, the upper and lower portions 123 and 125 are arranged with respect to each other such that an area of the lower portion overlaps an area of the upper portion, for example, in a region 127. That is, the free edges 123d and 125d may overlap. Upper and lower portions may be joined in seam region 127a of sides 123c and 125c and in seam region 127b of sides 123b and 125b, respectively. As such, region 127 is formed by an area of portions 123 and 125 that may move with respect to one another to expose receptacle 119 due to the fact that edges 123d and 125d are free. For example, the protective cover's receptacle can be exposed by causing the portions 123 and 125 to move in directions substantially perpendicular to the free edges as indicated by the arrows in FIG. 6 (e.g., by pulling the free edges away from each other).

In the embodiment of FIG. 6, free edge 125d of lower portion 125 forms an opening through which a cassette may be inserted into the protective cover. Upper portion 123 may then be pulled over the portion of the cassette extending above the opening and returned to its position underneath portion 125 to enclose the cassette. The overlap region 127 insures that no part of the cassette is uncovered. After the cassette is exposed to radiation, the cassette may be removed through the same opening in a fashion similar to how it was inserted. Alternately, while not explicitly shown FIG. 6, the protective cover 101 optionally may include one or more perforated edges similar to those discussed above. Also, by arranging both the opening and release on the back face as shown in FIG. 6, the surface of the protective cover that has primary contact with the patient can be entirely seamless to ensure protection against contaminants.

In some embodiments according to the present invention, a protective cover is made from a clear plastic material resistant to fluids such as blood and water as well as dust particles such as sand and/or dirt. The protective cover also may be made of a material that is resistant to various other chemical and/or biological agents. Additionally, the protective cover may be made of a generally puncture or tear resistant material (e.g., one that resists physical tampering or damage except in the area of a release that may be provided according to various embodiments discussed above).

In one aspect, a clear plastic envelope also facilitates the reading of any written material that may be placed on the cassette such as patient identification information, exposure information, etc. without having to remove the cassette from the envelope. However, according to other embodiments, the protective cover could be made of a material opaque to light in the visible spectrum. It should be appreciated that the protective cover may be substantially transparent to any high energy radiation used during the imaging process such that the envelope does not cast “shadows” on the image recording medium.

Accordingly, various embodiments permit cassettes to be stored in contaminated environments and/or employed in emergency situations, wherein contaminants such as blood may contact the cassette, without having to expend time consuming cleaning procedures and while reducing the chances that the cassette or the image recording medium will be damaged by the contaminants.

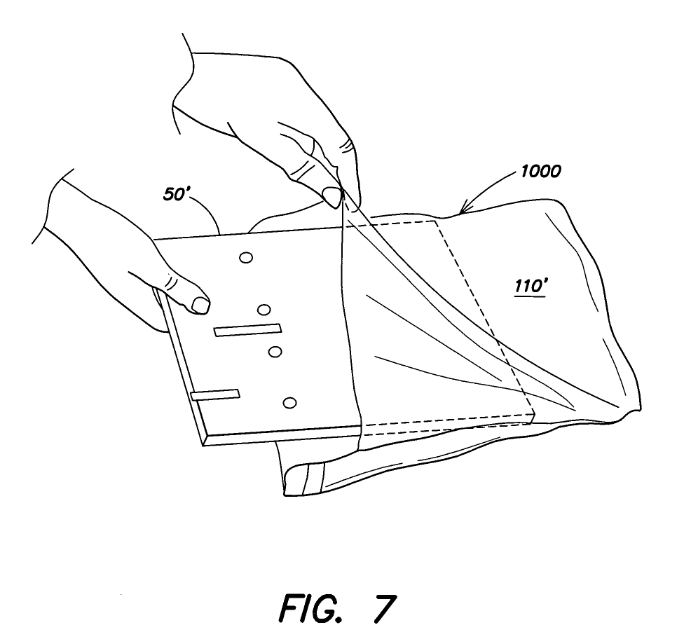

FIGS. 7-13 illustrate one method of protecting a cassette adapted to encase a phosphor medium (or film) according to the present invention. In FIG. 7, a cassette 50′ is shown being inserted into a plastic envelope 1000. Envelope 1000 is illustrated in an open position. An operator lifts up on a front face 110′ of the envelope in order to slide the cassette into the opening of the envelope. Cassette 50′, for example, may hold a phosphor plate capable of storing absorption information during an exposure to X-ray radiation.

In FIG. 8, the cassette 50′ has been fully inserted into the envelope. In order to properly secure the envelope, the operator lifts a protective tab 145′ off an adhesive strip 140′ on flap 130″ to expose the adhesive substance on the strip. Flap 130′ may be, for example, a foldable extension of the back face of the envelope.

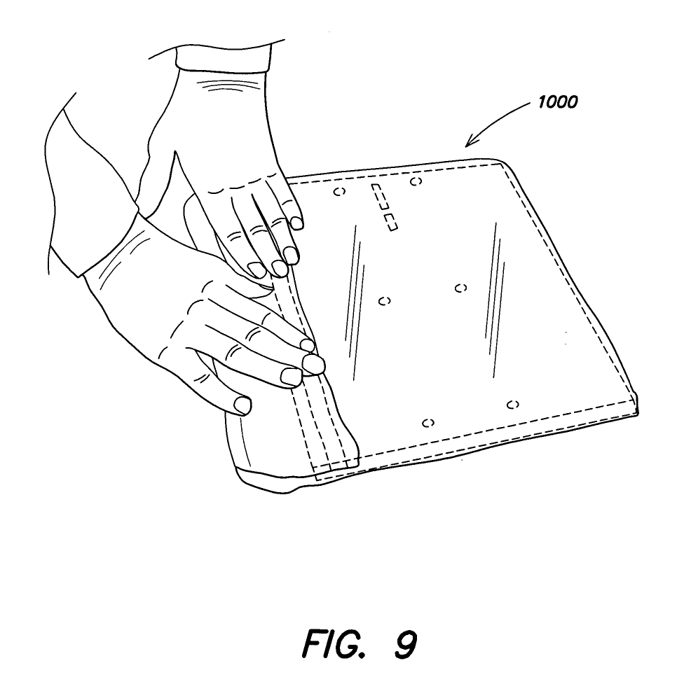

In FIG. 9, the operator folds the flap such that it overlaps the opening and presses the flap against the front face to secure the flap in a closed position. Once in a closed position, the cassette is fully enclosed in the envelope and various contaminants may be prevented from corroding, damaging, or contaminating the cassette and/or re-useable phosphor plate encased in the cassette. The protected cassette may then be stored or immediately employed to image a patient.

For example, a temporary or mobile medical facility may require that cassettes be stored, handled and/or used in conditions where it is impractical or impossible to sanitize the facility of contaminants. For instance, a protected cassette such as illustrated in FIG. 9 may be stored and used in a military medical installment that may be exposed to the outside environment or conditions substantially similar to the outside environment to reduce the risk of losing information or damaging the cassette and/or phosphor medium. The protected cassette may also be used in imaging conditions where a patient being imaged is bleeding or the cassette may contact bodily fluids of the patient and/or other undesirable substances (e.g., chemicals or medicines used in treatment, etc).

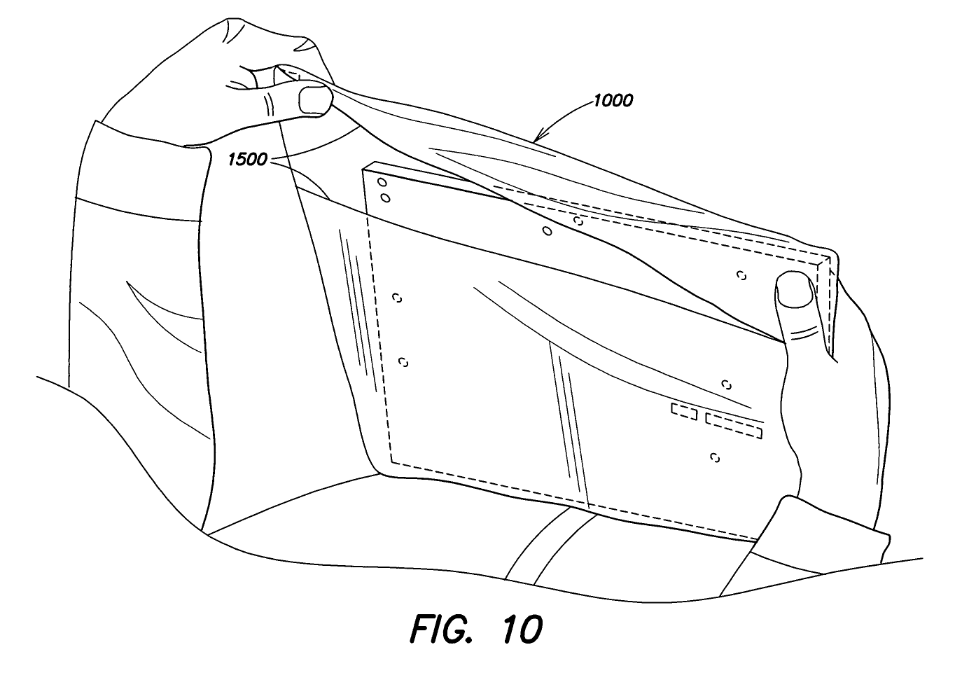

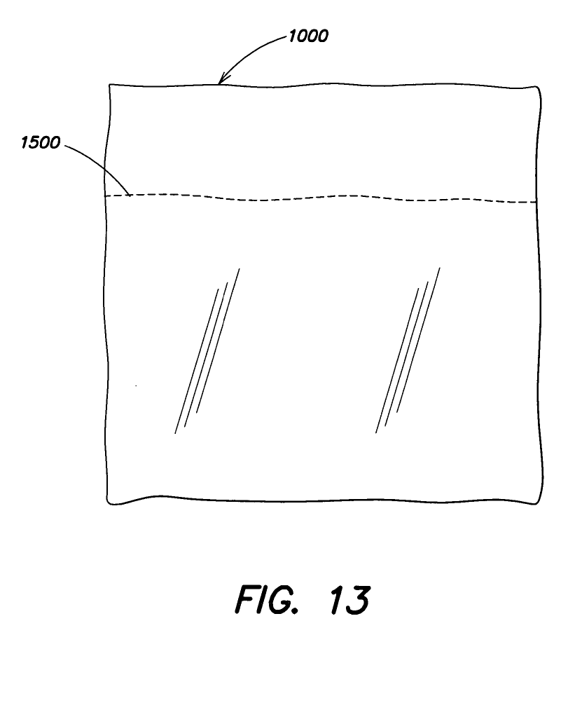

FIG. 10 illustrates the cassette being released from the envelope, for example, after the cassette has been exposed to X-ray radiation. The latent image produced on the image recording medium may be read from the plate by an image reader. As shown, the envelope is torn along a perforation line formed on a portion of the envelope. An exemplary perforation line 1500 is shown in FIG. 13. Once the envelope has been torn the cassette may be removed from the envelope.

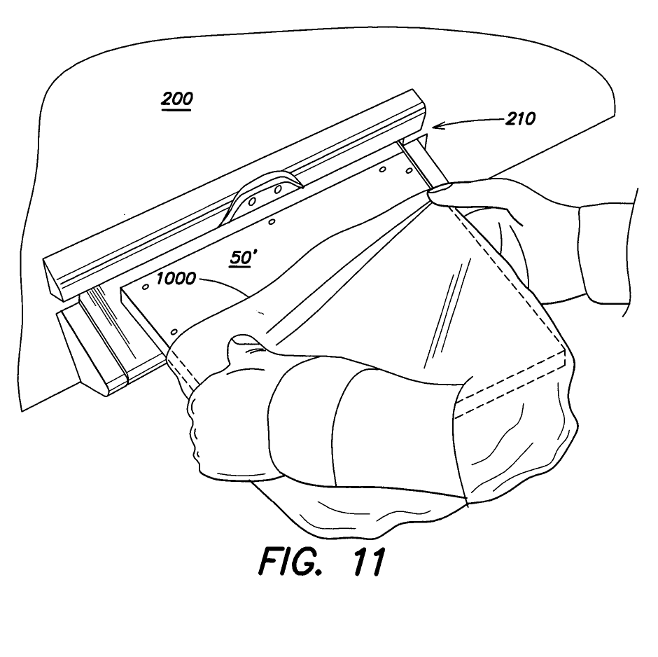

FIG. 11 illustrates the cassette being inserted into image reader 200 by placing the exposed portion of the cassette into loader 210 of the image reader. An exemplary image reader is described in the '748 application in connection with a description of methods for removing an image recording medium, typically a phosphor plate, from a cassette for scanning and the insertion of the image recording medium back into the cassette after reading the latent image. In FIG. 11, the envelope can be fully removed from the cassette which is now correctly loaded into the image reader such that the image recording medium may be removed for scanning and inserted back into the cassette for subsequent exposures.

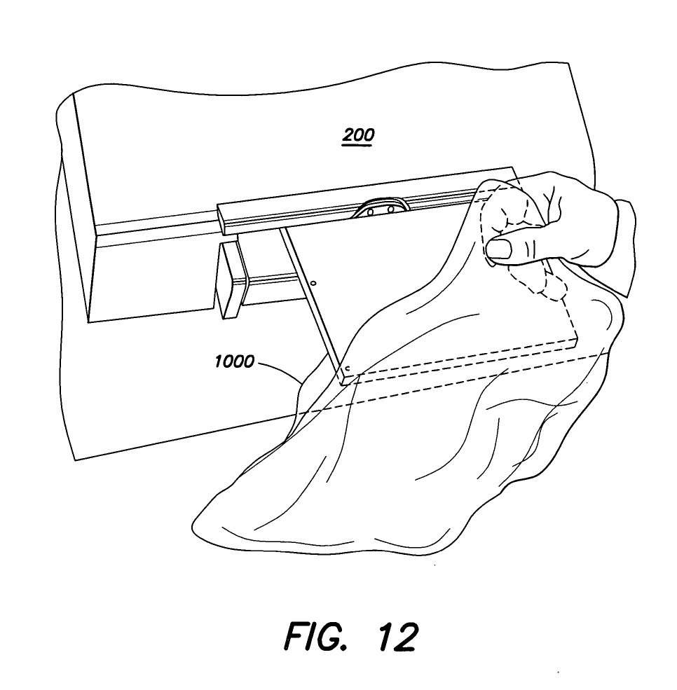

FIG. 12 depicts the cassette inserted into the image reader and the protective envelope fully removed. The envelope may then be disposed of in any appropriate manner. The protective cover may obviate time consuming and potentially damaging cleaning procedures that were previously required when the cassette was exposed to contaminants. After the image recording medium has been scanned and inserted back into the cassette, another envelope may be placed around the cassette and sealed as discussed in connection with FIGS. 7-9. As such, the cassette and image recording medium can be protected through multiple exposures, thereby extending the useful lifetime of the cassette and/or phosphor medium and reducing the risk of losing valuable image information.

It should be appreciated that the envelope need not be made to be disposable. For example, the envelope may be made from a washable material that can be cleaned and then reused. Such a reusable envelope may include a release that does not permanently alter the envelope, such as the release illustrated in FIG. 4 or some other fastening mechanism adapted to be engaged and released repeatedly.

Having described several embodiments of the invention in detail, various modifications and improvements will readily occur to those skilled in the art. Such modifications and improvements are intended to be within the scope of the invention. While some examples presented herein involve specific combinations of functions or structural elements, it should be understood that those functions and elements may be combined in other ways according to the present invention to accomplish the same or different objectives.

In particular, acts, elements and features discussed in connection with one embodiment are not intended to be excluded from a similar role in other embodiments. Accordingly, the foregoing description is by way of example only, and is not intended as limiting. For example, it is contemplated that the various embodiments can be employed in connection within any type of cassette and image recording medium (e.g., film or phosphor media for dental or medical applications) combination in conjunction with any combination of features, elements and/or methods of a protective cover.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

1. A protective cover for a cassette adapted to handle at least one image recording medium responsive to and recording information related to electromagnetic energy impinging on the image recording medium, the protective cover comprising:
a receptacle adapted to substantially enclose the cassette, the receptacle formed substantially by a material that reduces a possibility of at least one contaminant from contacting the cassette;
an opening through which the cassette may be inserted into the receptacle; and
a release through which the cassette may be removed from the receptacle.

2. The protective cover of claim 1, wherein the material is substantially transparent to radiation in at least an X-ray spectrum.

3. The protective cover of claim 1, wherein the material is substantially transparent to radiation in a visible spectrum.

4. The protective cover of claim 1, wherein the material is substantially resistant at least to human bodily fluids.

5. The protective cover of claim 1, wherein the release includes at least one perforation.

6. The protective cover of claim 1, wherein the opening through which the image recording cassette is inserted includes the release through which the cassette may be removed.

7. The protective cover of claim 1, wherein the receptacle is formed by a front face substantially joined to a back face except at a free edge forming the opening.

8. The protective cover of claim 7, wherein the back face has a flap portion extending beyond the free edge and adapted to be folded over the free edge to substantially block the opening when the protective cover is placed in a closed position.

9. The protective cover of claim 8, wherein the flap portion has an adhesive region adapted to secure the flap portion to the front face.

10. The protective cover of claim 8, wherein at least one of the flap portion and the front face includes fastening means adapted to secure the flap portion to the front face when the protective cover is in the closed position.

11. The protective cover of claim 7, wherein the release is formed proximate an edge of the front face other than the free edge by providing at least one tear line.

12. The protective cover of claim 7, wherein the release is formed proximate an edge of the back face by providing at least one tear line.

13. The protective cover of claim 8, wherein the release is formed by a tear line on the flap portion.

14. The protective cover of claim 1, wherein the receptacle is formed by a front face substantially joined with a back face, the back face having a first portion and a second portion separated by a first free edge and a second free edge, respectively, the first portion and the second portion arranged with respect to each other such that the second free edge overlaps the first free edge to form an overlap region to enclose the receptacle.

15. The protective cover of claim 14, wherein the overlap region can be manipulated to expose the receptacle by causing the first free edge to move in a direction substantially orthogonal to the first free edge and causing the second free edge to move in a direction substantially orthogonal to the second free edge thereby forming at least one of the opening and the release.

16. The protective cover of claim 1, wherein the receptacle is dimensioned to enclose a cassette adapted to handle medical image recording media.

17. The protective cover of claim 1, wherein the receptacle is dimensioned to enclose a cassette adapted to withstand stresses involved in medical imaging.

18. An image recording apparatus comprising:
an image recording medium responsive to and capable of storing information related to electromagnetic radiation impinging on the image recording medium;
a cassette substantially enclosing the image recording medium; and
at least one removable protective cover dimensioned to substantially enclose the cassette, the removable protective cover adapted to facilitate the prevention of at least one contaminant from contacting the cassette.

19. The image recording apparatus of claim 18, wherein the removable protective cover is intended to substantially enclose the cassette during at least one of storage and exposure of the image recording medium to X-ray radiation and removed during retrieval of one or more latent images from the image recording medium.

20. The image recording apparatus of claim 19, wherein the at least one removable protective cover includes means for inserting and removing the cassette from the at least one protective covering.

21. The image recording apparatus of claim 20, wherein the means for inserting and removing includes an opening in the at least one protective covering.

22. The image recording apparatus of claim 21, wherein the means for inserting and removing includes a release.

23. The image recording apparatus of claim 19, wherein the removable protective cover includes a plastic envelope.

24. The image recording apparatus of claim 19, in combination with an image reader having a loader adapted to accept the cassette, wherein the removable protective cover is removed before the cassette is inserted into the loader.

25. The image recording apparatus of claim 23, wherein the plastic envelope comprises:
a first open position to facilitate insertion of the image recording cassette into the envelope; and
a closed position adapted to substantially enclose the image recording cassette.

26. The image recording apparatus of claim 25, further comprising a first arrangeable portion to facilitate a first transition of the envelope from the first open position to the closed position.

27. The image recording apparatus of claim 26, wherein the first arrangeable portion facilitates a second transition of the envelope from the closed position to a second open position configured such that the image recording cassette can be removed from the envelope.

28. The image recording apparatus of claim 26, further comprising a second arrangeable portion that facilitates a second transition of the envelope from the closed position to a second open position configured such that the image recording medium can be removed from the envelope.

29. The image recording apparatus of claim 28, wherein the second arrangeable portion includes a perforation.

30. The image recording apparatus of claim 18, wherein the image recording medium is a phosphor plate for medical imaging.

31. The image recording apparatus of claim 18, wherein the cassette is adapted to withstand at least stresses involved in routine medical imaging.

32. A method of protecting a cassette containing an image recording medium responsive to electromagnetic radiation from at least one contaminant, the method comprising acts of:
inserting the cassette into a first protective envelope prior to a first exposure to the electromagnetic radiation;
providing the first exposure of the image recording medium to the electromagnetic radiation; and
removing the cassette from the first protective envelope subsequent to exposure to the electromagnetic radiation.

33. The method of claim 32, further comprising an act of acquiring at least one image from the image recording medium subsequent to the act of removing the cassette from the first protective envelope.

34. The method of claim 33, further comprising an act of inserting the cassette into a second protective envelope after the act of acquiring at least one image and prior to a second exposure to electromagnetic radiation subsequent to the first exposure.

35. The method of claim 34, wherein the act of acquiring at least one image includes an act of loading the cassette into an image reader.

36. The method of claim 35, wherein the image recording medium is a phosphor medium.

37. The method of claim 36, further comprising acts of:
removing the phosphor medium from the cassette prior to the act of acquiring at least one image; and
inserting the phosphor medium back into the cassette after the act of acquiring at least one image and before the act of inserting the cassette into the second protective envelope.

38. The method of claim 32, wherein the act of inserting the cassette into a first protective envelope includes an act of inserting the cassette through an opening in the protective envelope and the act of removing the cassette includes an act of actuating a release of the protective envelope.

39. The method of claim 38, further comprising an act of closing the envelope by substantially blocking the opening before the act of providing the first exposure of the image recording medium to electromagnetic radiation.

40. A protective cover for use with a cassette adapted to handle image recording media responsive to and capable of storing information in proportion to electromagnetic radiation impinging on a surface of the image recording media, wherein the use includes:
covering the cassette containing an image recording medium with the protective cover prior to a first exposure to X-ray radiation;
exposing the phosphor medium to X-ray radiation to record image information; and
removing the protective cover from the cassette after exposing the image recording medium.

41. The use of claim 40, wherein exposing the image recording medium includes positioning the cassette proximate to a patient to image internal structures of the patient.

42. The use of claim 40, further including storing the cassette after covering the cassette and before exposing the image recording medium.

43. The use of claim 40, further including covering the cassette with a second protective cover after removing the protective cover from the cassette.

44. The use of claim 43, wherein the image recording medium includes a phosphor medium.

45. The use of claim 43, further including acquiring at least one image from the phosphor medium after removing the protective cover and before the act of covering the cassette with the second protective cover.

46. The use of claim 45, further including:
removing the phosphor medium from the cassette prior to acquiring the at least one image; and
inserting the phosphor medium back into the cassette after acquiring the at least one image and before covering the cassette with the second protective cover.
